(19) United States
(12) Patent Application Publication
(10) Pub. No.: US 2026/0038229 A1
(43) Pub. Date: Feb. 5, 2026

(54) PILL DETECTION AND COUNTING USING CASCADING SEGMENTATION

(71) Applicant: Scientific Industries Inc., Bohemia, NY (US)

(72) Inventors: Gregory Smith, Pittsburgh, PA (US); Drew Degentesh, Pittsburgh, PA (US); Christopher Holliday, Pittsburgh, PA (US); Karl Nowosielski, Pearl River, NY (US); Lukasz Grabowski, Bialystok (PL)

(21) Appl. No.: 18/788,452

(22) Filed: Jul. 30, 2024

(51) Int. Cl. G06V 10/26; G06V 10/22; G06V 10/764; G06V 20/60

(52) U.S. Cl. CPC G06V 10/267; G06V 10/225; G06V 10/764; G06V 20/60

(57) ABSTRACT

A method, apparatus, non-transitory computer readable medium, apparatus, and system for counting objects includes first obtaining a digital image. Then, embodiments segment the digital image using a first segmentation parameter to obtain a first region and a second region. Embodiments then segment the second region based on a size of the second region using a second segmentation parameter different from the first segmentation parameter to obtain a third region. Lastly, embodiments generate a count of objects in the digital image by incrementing based on the first region and the third region.

### BACKGROUND

The following relates generally to image processing, and more specifically to counting objects using cascading segmentation on a digital image. Image processing is a type of data processing that involves the manipulation of an image to achieve the desired output, typically utilizing specialized algorithms and techniques. For example, image processing may be used to identify objects in an image, add blur, recognize movement such as gestures, and the like. One application of image processing is to process a digital image to identify a count of objects in the image's field of view.

Counting objects is an important task in many industries. For example, in a pharmacy the task of counting pills is repeated many times each day. However, in many cases, this task is performed manually, which may be time consuming and may lead to mistakes. Additionally, systems that perform counting tasks automatically are often suitable only for a very particular size and shape of object, or may require extensive training of an object recognition pattern.

### SUMMARY

Embodiments of the present inventive concept include systems and methods for counting objects by performing a cascading segmentation operation on a digital image. Embodiments include an object counting apparatus with an image sensor and a processing component. The processing component includes a segmentation component which is configured to perform segmentation on a digital image to obtain a set of labels. The segmentation operations may include morphological operations such as erode, threshold, and dilate operations, and may further include a watershed operation with a first parameter. The parameter may be, for example, a sensitivity parameter. In some aspects, a first label represents a background, and subsequent labels represent objects on the background. Since digital images lack explicit depth information, the segmentation component is further configured to identify any overlapping objects by performing a local segmentation operation on regions that are above a threshold size (e.g., area) using a second parameter different from the first parameter. For example, the second parameter may have a different sensitivity value. In some embodiments, this process repeats until no overlapping objects are identified. Then, embodiments may display the count of the objects via a user interface.

A method for counting objects using cascading segmentation is described. One or more aspects of the method include obtaining a digital image; segmenting the digital image using a first segmentation parameter to obtain a first region and a second region; segmenting the second region based on a size of the second region using a second segmentation parameter different from the first segmentation parameter to obtain a third region; and generating a count of objects in the digital image by incrementing based on the first region and the third region.

Some examples of the method, apparatus, non-transitory computer readable medium, and system further include capturing the digital image with an image sensor. Some examples further include identifying a marker in the digital image. Some examples further include cropping the digital image based on the marker.

Some examples of the method, apparatus, non-transitory computer readable medium, and system further include obtaining object shape information prior to segmenting the digital image, wherein the digital image is segmented based on the object shape information. Some examples further include obtaining object color information prior to segmenting the digital image, wherein the digital image is segmented based on the object color information.

Some examples of the method, apparatus, non-transitory computer readable medium, and system further include classifying the first region as a discrete object based on a size of the first region, wherein the count is based on the classification of the first region. Some examples further include comparing a size of the first region to a median region size, wherein the classification of the first region is based on the comparison. Some examples further include classifying the second region as an aggregate object based on a size of the second region, wherein the second region is segmented based on the classification of the second region. Some examples further include classifying a fourth region as a fragment object based on a size of the fourth region.

Some examples of the method, apparatus, non-transitory computer readable medium, and system further include performing a watershed process on the digital image, wherein the first segmentation parameter comprises a first watershed parameter. Some examples further include performing the watershed process on the second region, wherein the second segmentation parameter comprises a second watershed parameter. Some examples further include performing a first segmentation algorithm to obtain a fourth region. Some examples further include performing a second segmentation algorithm different from the first segmentation algorithm on the fourth region to obtain the third region. Some examples further include iteratively segmenting regions of the digital image using different segmentation parameters until a termination condition is met, wherein the count is generated based on the termination condition. Some examples further include displaying the count of objects via a user interface.

An apparatus for counting objects using cascading segmentation is described. One or more aspects of the apparatus include a light source; an image sensor; a textured surface disposed between the light source and the digital camera, wherein the textured surface is configured to separate objects; and a processing component configured to generate a count of the objects by segmenting a digital image captured by the image sensor by using a first segmentation parameter to obtain a first region and a second region, and by segmenting the second region based on a size of the second region using a second segmentation parameter different from the first segmentation parameter to obtain a third region.

Some examples of the apparatus, system, and method further include a top-down digital camera configured to capture an image of the objects on a tray. Some examples further include a front-facing digital camera configured to decode a barcode of an object container. In some aspects, the processing component is further configured to iteratively segment regions of the digital image using different segmentation parameters until a termination condition is met, wherein the count is generated based on the termination condition.

An apparatus for counting objects using cascading segmentation is described. One or more aspects of the apparatus include obtaining a digital image; segmenting the digital image using a first segmentation parameter to obtain a first region and a second region; segmenting the second region based on a size of the second region using a second segmentation parameter different from the first segmentation parameter to obtain a third region; and generating a count of objects in the digital image by incrementing based on the first region and the third region.

Some examples of the apparatus, system, and method further include obtaining object shape information prior to segmenting the digital image, wherein the digital image is segmented based on the object shape information. Some examples further include obtaining object color information prior to segmenting the digital image, wherein the digital image is segmented based on the object color information.

### BRIEF DESCRIPTION OF THE DRAWINGS

FIG. 1 shows an example of a perspective view of an object counting apparatus according to aspects of the present disclosure.

FIG. 2 shows an example of a block diagram of an object counting apparatus according to aspects of the present disclosure.

FIG. 3 shows an example of a method for generating a count of objects on a surface according to aspects of the present disclosure.

FIG. 4 shows an example of a method for verifying regions using shape verification according to aspects of the present disclosure.

FIG. 5 shows an example of a method for verifying regions using color verification according to aspects of the present disclosure.

FIG. 6 shows an example of a method for counting objects according to aspects of the present disclosure.

FIG. 7 shows an example of a method for displaying a pill count to a user according to aspects of the present disclosure.

FIG. 8 shows an example of a computing device according to aspects of the present disclosure.

### DETAILED DESCRIPTION

The present disclosure describes systems and methods for counting objects using an imaging device. In some of the examples herein, the system may be described in the context of counting pills, but it is not limited thereto. Rather, the systems and methods may be used for counting a wide variety of objects and the example of counting pills is used for clarity and convenience.

Some conventional object counting methods rely on specific pattern recognition of the shapes and colors of the objects to be counted. This approach requires extensive dedicated training on ground truth data, and does not generalize to unseen objects. Other conventional methods rely on segmentation through edge detection to identify contours. In some cases, this approach isn't suitable for translucent objects such as some pill capsules.

Embodiments of the present disclosure are configured to count objects using a cascading segmentation method. Embodiments first capture a digital image of a surface on which the objects are disposed. Embodiments then perform a background subtraction operation on the digital image to further separate the objects in the foreground from the background. Embodiments then perform an initial segmentation including morphological operations on the digital image to identify an initial set of labels. “Labels,” as used herein, refers to a set of regions within a digital image that are distinct from each other, where each region of the regions is enumerated with an identifying label. Then, for each region that is determined to be a “blob,” that is, a region that is larger than the other regions, embodiments perform a local segmentation operation on the region to further separate it, where the local segmentation operation varies one or more parameters from the initial segmentation operation. Embodiments may repeat this process one or more additional times for any remaining blobs. This iterative process may be referred to as “cascading segmentation” Embodiments may then display the count of the labels (minus the label corresponding to the background, if applicable) to the user.

According to some aspects, the background subtraction operation increases the reliability of the detection of transparent and translucent objects. In some examples, embodiments validate the set of final set of labels using a shape verification process, a color verification process, or both. According to some aspects, the object counting apparatus is configured to identify and maintain an accurate count of objects even while the objects are in motion on the surface.

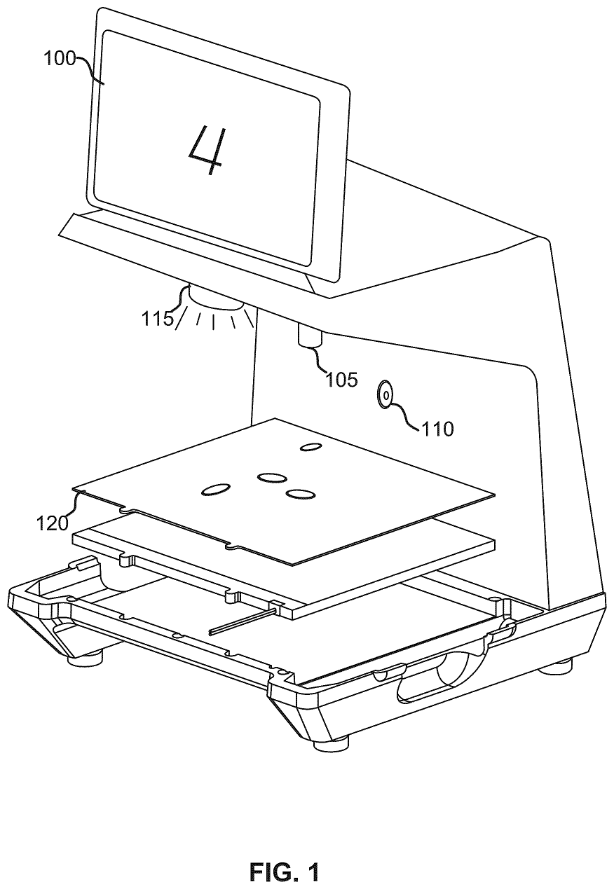

FIG. 1 shows an example of a perspective view of an object counting apparatus according to aspects of the present disclosure. The example shown includes display 100, top-down digital camera 105, front-facing digital camera 110, light source 115, and textured surface 120.

Display 100 may display a count of objects to a user. Display 100 may further display an indication if the count is not reliable. For example, the indication may be displayed if any of the objects has failed a shape verification or a color verification process. A display may comprise a conventional monitor, a monitor coupled with an integrated display, an integrated display (e.g., display 100), or other means for viewing associated data or processing information.

Top-down digital camera 105 is configured to capture an image of textured surface 120, and any objects disposed on textured surface 120. Top-down digital camera 105 may include a lens and an image sensor, such as a CMOS sensor. According to some aspects, top-down digital camera 105 captures a visible light image.

Front-facing digital camera 110 is configured to capture an image at a different angle than top-down digital camera 105. According to some aspects, images from front-facing digital camera 110 are not used during the counting process, but embodiments are not limited thereto. In some cases, front-facing digital camera 110 is configured to identify and decode encoded information such as bar-codes, QR-codes, and the like.

Light source 115 is configured to illuminate surface 120. Embodiments of light source 115 include a light emitting diode (LED). In some embodiments, light source 115 is disposed above the surface 120, e.g., as shown in FIG. 1. In some embodiments, light source 115 is additionally or alternatively disposed beneath the surface 120. Light source 115 may further include a light diffuser that is disposed between the light source 115 and the surface 120, where the diffuser diffuses light from the light source 115.

Surface 120 is configured to separate objects that are placed on it. For example, surface 120 may include a texture with ridges and valleys that provide resting regions for the objects. According to some aspects, textured surface 120 is disposed between the light source 115 and the digital camera.

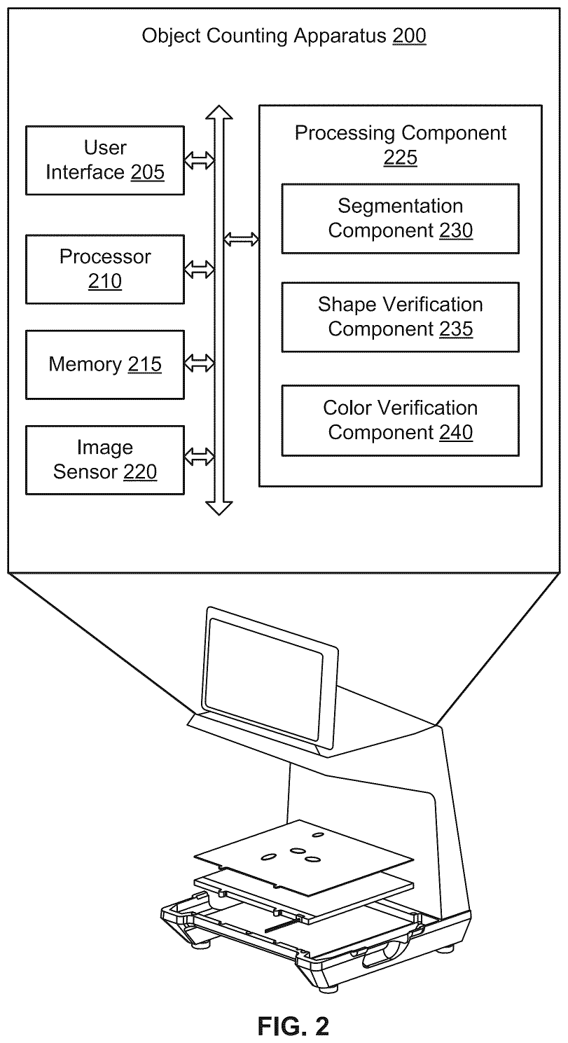

FIG. 2 shows an example of a block diagram of an object counting apparatus 200 according to aspects of the present disclosure. The example shown includes object counting apparatus 200, user interface 205, processor 210, memory 215, image sensor 220, and processing component 225.

A user interface 205 may enable a user to interact with a device. In some embodiments, the user interface 205 include an audio device, such as an external speaker system, an external display device such as a display as described with reference to FIG. 1, or an input device (e.g., remote control device interfaced with the user interface directly or through an IO controller module). In some cases, a user interface 205 may be a graphical user interface (GUI). According to some aspects, user interface 205 includes a GUI that enables a user to seamlessly switch between an operating system application and a counting application, where the counting application displays a count of objects detected by object counting apparatus 200.

Processor 210 is configured to execute machine instructions. For example, processor 210 may be configured to execute code or instructions encapsulated in processing component 215. A processor 210 is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, the processor is configured to operate a memory 215 array using a memory controller. In other cases, a memory controller is integrated into the processor 210. In some cases, the processor 210 is configured to execute computer-readable instructions stored in a memory 215 to perform various functions. In some embodiments, processor 210 includes special purpose components for modem processing, baseband processing, digital signal processing, or transmission processing.

Memory 215 is configured to store data used by object counting apparatus 200, such as captured images, pre-cached shape data, computer-readable instructions, and the like. Examples of a memory device include random access memory (RAM), read-only memory (ROM), or a hard disk. Examples of memory devices include solid state memory and a hard disk drive. In some examples, memory 215 is used to store computer-readable, computer-executable software including instructions that, when executed, cause processor 210 to perform various functions described herein. In some cases, the memory 215 contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within memory 215 store information in the form of a logical state.

Image sensor 220 is configured to capture images of its surroundings. According to some aspects, the image sensor 220 includes a front-facing camera, a top-down camera, or a combination of the two. Image sensor 220 may include an optical instrument for recording or capturing images, which may be stored locally, transmitted to another location, etc. For example, image sensor 220 may capture visual information using one or more photosensitive elements that may be tuned for sensitivity to a visible spectrum of electromagnetic radiation. The resolution of such visual information may be measured in pixels, where each pixel may relate an independent piece of captured information. In some cases, each pixel may thus correspond to one component of, for example, a two-dimensional (2D) Fourier transform of an image. Computation methods may use pixel information to reconstruct images captured by the device. In a camera, an image sensor 220 may convert light incident on a camera lens into an analog or digital signal. An electronic device may then display an image on a display panel based on the digital signal.

Processing component 225 is configured to identify and validate objects in a digital image using image segmentation methods. In digital image processing and computer vision, image segmentation is the process of partitioning a digital image into multiple segments (sets of pixels, also known as image objects). The goal of segmentation is to simplify and/or change the representation of an image into something that is more meaningful and easier to analyze. Image segmentation is typically used to locate objects and boundaries (lines, curves, etc.) in images. More precisely, image segmentation is the process of assigning a label to every pixel in an image such that pixels with the same label share certain characteristics.

According to some aspects, processing component 225 is configured to generate a count of the objects by segmenting a digital image captured by the image sensor 220 by using a first segmentation parameter to obtain a first region and a second region, and by segmenting the second region based on a size of the second region using a second segmentation parameter different from the first segmentation parameter to obtain a third region. In one aspect, processing component 225 includes segmentation component 230, shape verification component 235, and color verification component 240.

Segmentation component 230 is configured to perform one or more segmentation operations on an image. For example, segmentation component 230 may include computer readable instructions that process an image by performing an erode operation, a threshold operation, a dilate operation, a watershed operation, or a combination thereof. The erode operation involves eroding away the boundaries of regions of foreground pixels, which helps in removing small noise and disconnecting linked objects. The threshold operation adjusts pixel values in an image to segment regions based on their intensity levels, creating a binary image where the pixels are either 0 or 1. The dilate operation uses a structuring element to increase the size of foreground objects, typically used to accentuate features and close small holes within the objects.

A watershed operation is a type of segmentation operation. It involves treating the digital image as a topographical landscape, where pixel values represent elevation. The process begins by identifying the regional minima, which are areas in the image that correspond to the lowest points in each catchment basin. Water is considered to flow from higher elevations to these minima, filling up the catchment basins. As the basins fill, they expand until they meet at ridge lines, which are elevated areas that act as boundaries between adjacent catchment basins. These ridge lines effectively delineate where one object ends and another begins, ensuring each object is segmented from its neighbor. This operation classifies pixels into three types: those that belong to a regional minimum, those within a catchment basin, and those along the ridge lines. According to some aspects, the segmentation component 230 assigns a label to each region that consists of regional minimum and catchment basin pixels.

Segmentation component 230 may further perform a local watershed operation on a region of the digital image using different parameters, such as different values of sensitivity for the watershed operation. The value of the sensitivity parameter determines how finely the image is segmented into distinct basins and ridges. A higher sensitivity setting lowers the threshold for identifying potential barriers, resulting in the creation of more catchment basins from minor variations in the image. Conversely, a lower sensitivity setting raises this threshold, which may lead to fewer basins as only pronounced differences in elevation are recognized as boundaries. According to some aspects, the segmentation component 230 iteratively increases a sensitivity parameter.

According to some aspects, segmentation component 230 segments the digital image using a first segmentation parameter to obtain a first region and a second region. A first region may include sub-regions corresponding to objects of nominal, consistent, or expected size. The second region may include a region that is larger than other regions, e.g., larger than a median region size. In some examples, segmentation component 230 segments the second region based on a size of the second region using a second segmentation parameter different from the first segmentation parameter to obtain a third region.

In some examples, segmentation component 230 classifies the first region as a discrete object based on a size of the first region, where the count is based on the classification of the first region. In some examples, segmentation component 230 compares a size of the first region to a median region size, where the classification of the first region is based on the comparison. In some examples, segmentation component 230 classifies the second region as an aggregate object based on a size of the second region, where the second region is segmented based on the classification of the second region. In some examples, segmentation component 230 performs a watershed process on the digital image, where the first segmentation parameter includes a first watershed parameter. The first watershed parameter may be a first value of a sensitivity parameter. In some examples, segmentation component 230 performs the watershed process on the second region, where the second segmentation parameter includes a second watershed parameter.

In some examples, segmentation component 230 performs a first segmentation algorithm to obtain a fourth region. In some examples, segmentation component 230 performs a second segmentation algorithm different from the first segmentation algorithm on the fourth region to obtain the third region. The second segmentation algorithm may be, but is not limited to, a local-max watershed algorithm, a local thinning fracture algorithm, or connected component analysis. The local-max watershed algorithm segments the image by initiating the watershed from the highest intensity pixels, enhancing the precision in identifying distinct objects. The local thinning fracture algorithm reduces the region to its skeletal structure and then uses these thin lines to separate connected objects into individual components. Connected component analysis labels distinct areas based on their connectivity, grouping pixels into components based on predefined criteria to identify separate entities within the image. In some examples, segmentation component 230 iteratively segments regions of the digital image using different segmentation parameters until a termination condition is met, where the count is generated based on the termination condition.

According to some aspects, shape verification component 235 obtains object shape information prior to segmenting the digital image, where the digital image is segmented based on the object shape information. In some embodiments, the object counting apparatus 200 performs an initial calibration on one or more types of objects to obtain shape data. For each type of object, the object counting apparatus 200 may store a nominal length and width. Then, during the counting, the shape verification component 235 may compare the shape of each identified region against the nominal length and width for the type of object being counted. If any objects that deviate significantly from the nominal length and width, the shape verification component 235 may send an indication that the count is not verified via the user interface 205. A significant deviation may be, for example, a threshold percentage of the nominal length or width, such as 10%.

According to some aspects, color verification component 240 obtains object color information prior to segmenting the digital image, where the digital image is segmented based on the object color information. In some embodiments, the initial calibration further includes color data for each type of object. For each type of object, the object counting apparatus 200 may store a nominal color. In some cases, this nominal color is a median color in the Lab* color space, which is used for its ability to approximate human visual perception by separating color into luminance and color-opponent dimensions. During the counting process, color verification component 240 compares the color of each identified region to the nominal color for the object type being counted. If any objects that deviate significantly from the nominal color, the color verification component 240 may send an indication that the count is not verified via the user interface 205. A significant deviation may be, for example, a threshold distance from the nominal color.

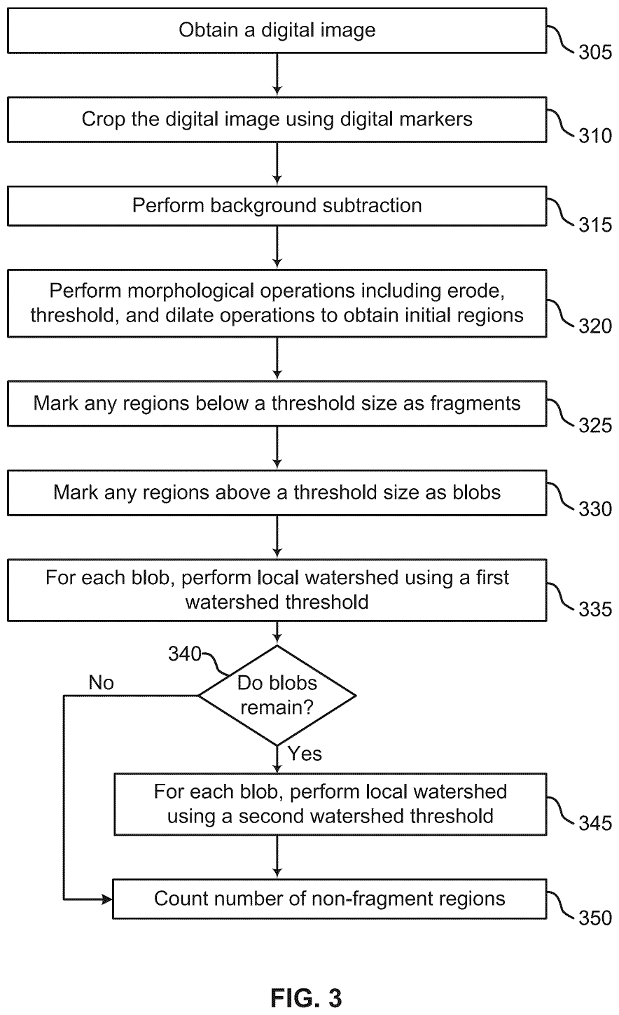

FIG. 3 shows an example of a method 300 for generating a count of objects on a surface according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations. Herein, this process may be referred to as “cascading segmentation.”

At operation 305, the system obtains a digital image. The system may, for example, capture a digital image using an image sensor as described with reference to FIG. 2. Particularly, the system may capture the digital image using a top-down camera of the image sensor.

At operation 310, the system crops the digital image using digital markers. Digital markers are scale and rotationally invariant shapes that are placed in the image field to facilitate accurate and consistent image cropping and orientation. These markers are designed to be easily detectable regardless of their size or how they are rotated in the image, ensuring that the cropping algorithm can precisely locate the area of interest in every image captured. An example of such digital markers is the ArUco markers. ArUco markers include black and white square patterns that can be uniquely identified. According to some aspects, the cropped image is cropped such that the digital markers are no longer in the field of view.

At operation 315, the system performs background subtraction (BGS) to isolate the foreground objects from the background in the digital image. This process involves updating the background model when the tray is identified as clear, which aids in adapting to changes in lighting conditions. The tray is considered clear based on two methods depending on the configuration: the first method counts the number of foreground pixels and determines clarity if this count is below a specified threshold; the second method assesses the overall image contrast and deems the tray clear when this contrast falls below another predefined level. Updating the background model may include identifying a set of colors or other characteristics associated with the background.

At operation 320, the system performs morphological operations including erode, threshold, and dilate operations to obtain initial regions. The erode operation involves eroding away the boundaries of regions of foreground pixels, which helps in removing small noise and disconnecting linked objects. The threshold operation adjusts pixel values in an image to segment regions based on their intensity levels, creating a binary image where the pixels are either 0 or 1. The dilate operation uses a structuring element to increase the size of foreground objects, typically used to accentuate features and close small holes within the objects. According to some aspects, the system first obtains foreground masks before applying morphological operations on each mask, and in some cases, a first global watershed operation. The watershed process is delineated in the description of FIG. 2., and particularly in the description for the segmentation component. The foreground masks may be obtained using, for example, Otsu's threshold algorithm or the triangle threshold algorithm. After the morphological operations, the image may have an initial set of regions. The set of regions may include a background region, and regions for each object on the surface. The system may ignore the background region for the remainder of the operations.

At operation 325, the system marks any regions below a threshold size as fragments. For example, the system may analyze all of the object regions to determine an average or a median size. Any object that is smaller than this size by a threshold amount may be further labeled as a “fragment.” In the counting pills context, a fragment may indicate that a piece of a pill has been broken off, and should be discarded. According to some aspects, the processing component may highlight this pill as a fragment on the display of the user interface.

At operation 330, the system marks any regions above a threshold size as blobs. For example, the system may label any object above the median or average size as a blob. In the pill counting context, a blob may indicate that one or more pills are overlapping each other on the surface.

At operation 335, the system performs, for each blob, a local watershed using a first watershed threshold. The objective of the local watershed is to break up the blob into multiple regions that are close to the average or median size. The watershed process is delineated in the description of FIG. 2., and particularly in the description for the segmentation component. A first watershed threshold may be, for example, a first value of a watershed sensitivity parameter.

At operation 340, the system checks if any blobs remain after the local watershed operations using the first watershed threshold. If blobs do remain, the system proceeds to operation 345.

At operation 345, the system performs, for each blob, a local watershed a second watershed threshold. For example, the second watershed threshold may be a second value of a watershed sensitivity parameter that is different from the first value of the watershed sensitivity parameter. The sensitivity parameter is described with reference to FIG. 2.

At operation 350, the system counts number of non-fragment regions. The system may, for example, display the count of the non-fragment regions on the display of the user interface. Optionally, the system may validate each of the regions using color or shape validation, which will now be described.

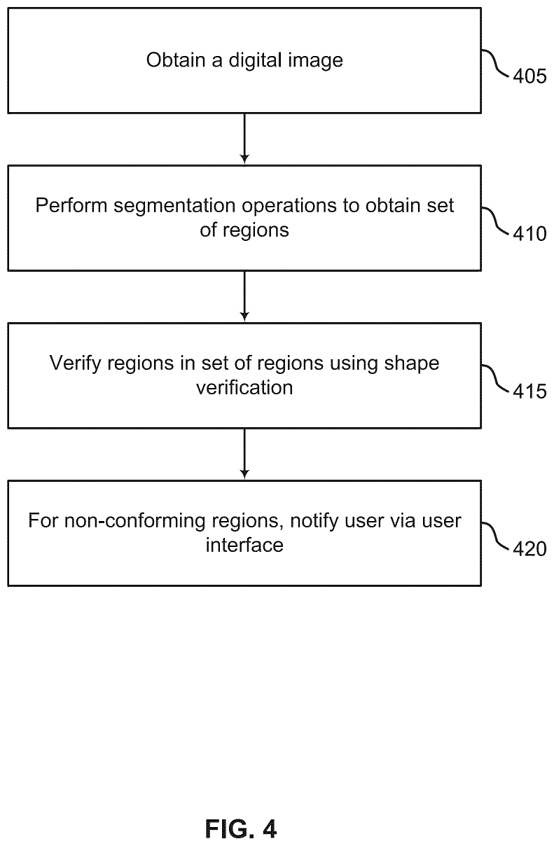

FIG. 4 shows an example of a method 400 for verifying regions using shape verification according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 405, the system obtains a digital image. The system may, for example, capture a digital image using an image sensor as described with reference to FIG. 2. Particularly, the system may capture the digital image using a top-down camera of the image sensor.

At operation 410, the system performs segmentation operations to obtain set of regions. The system may perform the segmentation operations that were described with reference to FIG. 3.

At operation 415, the system verifies regions in set of regions using shape verification. In some cases, the shape verification entails measuring nominal dimensions of the objects corresponding to the regions in the image, such as a nominal length and a nominal width. This measurement may be performed in an initial calibration phase, or may be performed during the counting procedure. Then, any objects that deviate from the nominal dimensions by more than a threshold percent may be marked as unverified shapes. For example, in the pill counting context, if the pills are smaller than the nominal dimensions by a threshold, the pills may be marked as fragments. If the pills are larger than the nominal dimensions by another threshold, the pills may be marked as blobs. In at least one embodiment, the shape verification includes learning additional geometry about the type of objects being counted, including but not limited to shape contours, concavity and convexity, and other characteristics.

At operation 420, the system notifies the user of any non-conforming regions via the user interface. For example, the system may highlight any of the regions that are not shape-verified on the display of the user interface, or may indicate the present count of the objects is not verified.

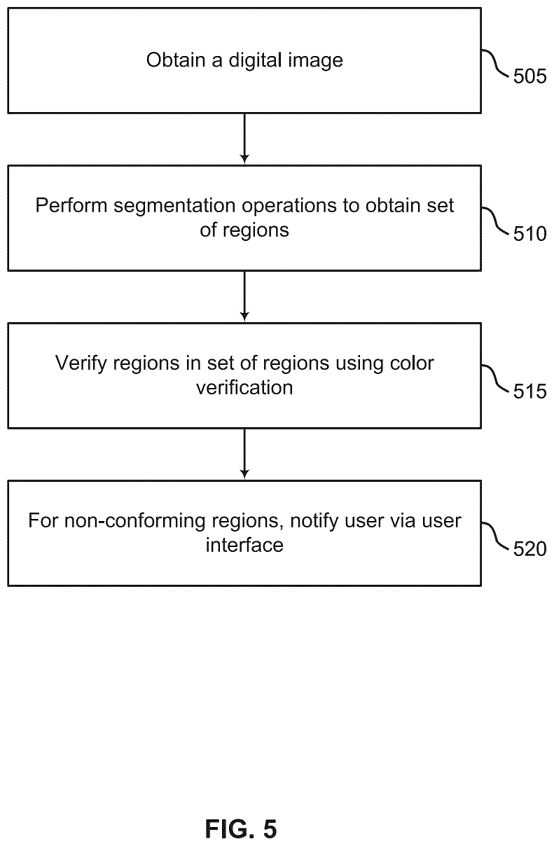

FIG. 5 shows an example of a method 500 for verifying regions using color verification according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 505, the system obtains a digital image. The system may, for example, capture a digital image using an image sensor as described with reference to FIG. 2. Particularly, the system may capture the digital image using a top-down camera of the image sensor.

At operation 510, the system performs segmentation operations to obtain set of regions. The system may perform the segmentation operations that were described with reference to FIG. 3.

At operation 515, the system verifies regions in set of regions using color verification. This verification process involves analyzing each region's color characteristics within the digital image to determine if they deviate from a predetermined nominal color. The nominal color for each type of object may be established during a calibration phase or may be dynamically determined at use time. This color may be represented in the Lab* color space, which is chosen for its effectiveness in mirroring human visual perception by isolating lightness and color-opponent dimensions. If a region's color significantly differs from the nominal color beyond a predefined threshold distance in this color space, it is flagged as a non-conforming region.

At operation 520, the system notifies the user of any non-conforming regions via the user interface. For example, the system may highlight any of the regions that are not color-verified on the display of the user interface, or may indicate the present count of the objects is not verified.

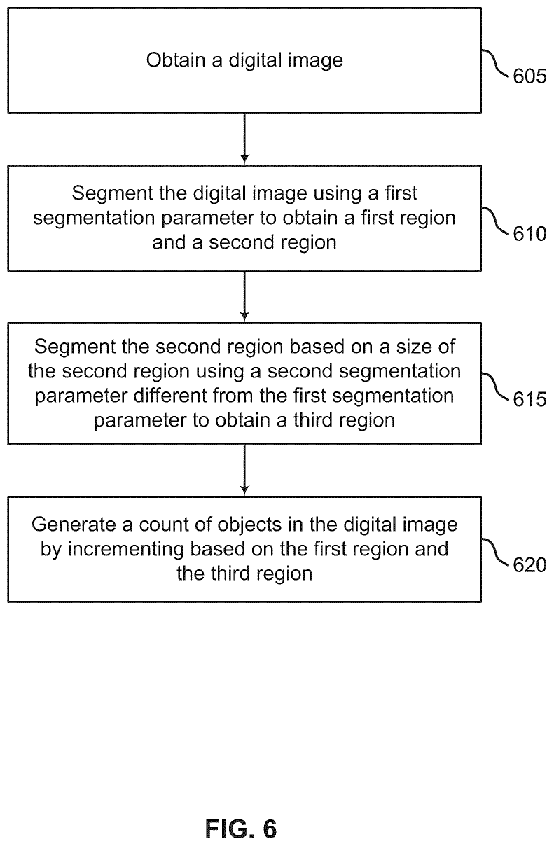

FIG. 6 shows an example of a method 600 for counting objects according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 605, the system obtains a digital image. In some cases, the operations of this step refer to, or may be performed by, an object counting apparatus as described with reference to FIG. 2. Particularly, a top-down camera of the object counting apparatus may capture the digital image. The digital image may be, for example, a color image in an RGB space.

At operation 610, the system segments the digital image using a first segmentation parameter to obtain a first region and a second region. In some cases, the operations of this step refer to, or may be performed by, a segmentation component as described with reference to FIG. 2. The first segmentation parameter may be, for example, a first value of a watershed sensitivity parameter, though embodiments are not necessarily limited thereto. For example, the first segmentation parameter may be a first segmentation algorithm. An example of the segmentation process and the first segmentation parameter is described with reference to FIG. 3. In an example of counting pills, the first region may represent a pill of expected size, and the second region may represent a blob that is larger than the expected size for a pill.

At operation 615, the system segments the second region based on a size of the second region using a second segmentation parameter different from the first segmentation parameter to obtain a third region. In some cases, the operations of this step refer to, or may be performed by, a segmentation component as described with reference to FIG. 2. The third region may be, for example, a pill of expected size, similar in dimensions to the first region. The second segmentation parameter may be, for example, a second value of a watershed sensitivity parameter different from the first value. However, embodiments are not limited thereto, and the second segmentation parameter may refer to a second segmentation algorithm such as local-max watershed, a local thinning fracture algorithm, connected component analysis, or some combination thereof.

At operation 620, the system generates a count of objects in the digital image by incrementing based on the first region and the third region. In some cases, the operations of this step refer to, or may be performed by, a processing component as described with reference to FIG. 2. For example, the processing component may count the number of all regions that are of expected size, and display this count to a user via a display of a user interface. In some embodiments, the processing component further validates the regions using shape validation or color validation as described with reference to FIGS. 4-5.

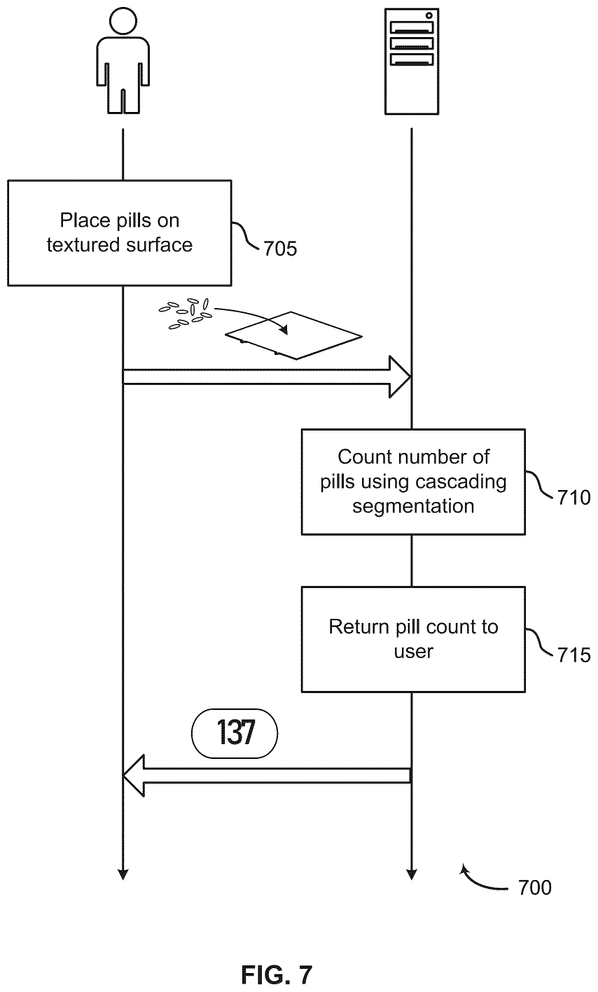

FIG. 7 shows an example of a method 700 for displaying a pill count to a user according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 705, a user places pills on a textured surface. For example, the textured surface may be a part of an objecting counting apparatus as described with reference to FIGS. 1-2. According to some aspects, the textured surface includes ridges and valleys that cause objects placed thereon to naturally separate.

At operation 710, the system counts number of pills using cascading segmentation. For example, the system may capture a digital image of the pills on the textured surface, and then obtain an initial set of labels using background subtraction, foreground masking, morphological operations, and a first watershed operation. Then, for any region that is larger than is expected for the pill, the system may perform a local second watershed operation that is different from the first watershed operation in some way, such as in the value of a watershed sensitivity parameter. Additional detail regarding the cascading segmentation process is described with reference to FIG. 3.

At operation 715, the system returns the pill count to the user. For example, the system may count the number of regions that are of expected size and show this count on a display of a user interface. According to some aspects, the system further verifies the regions using shape or color verification.

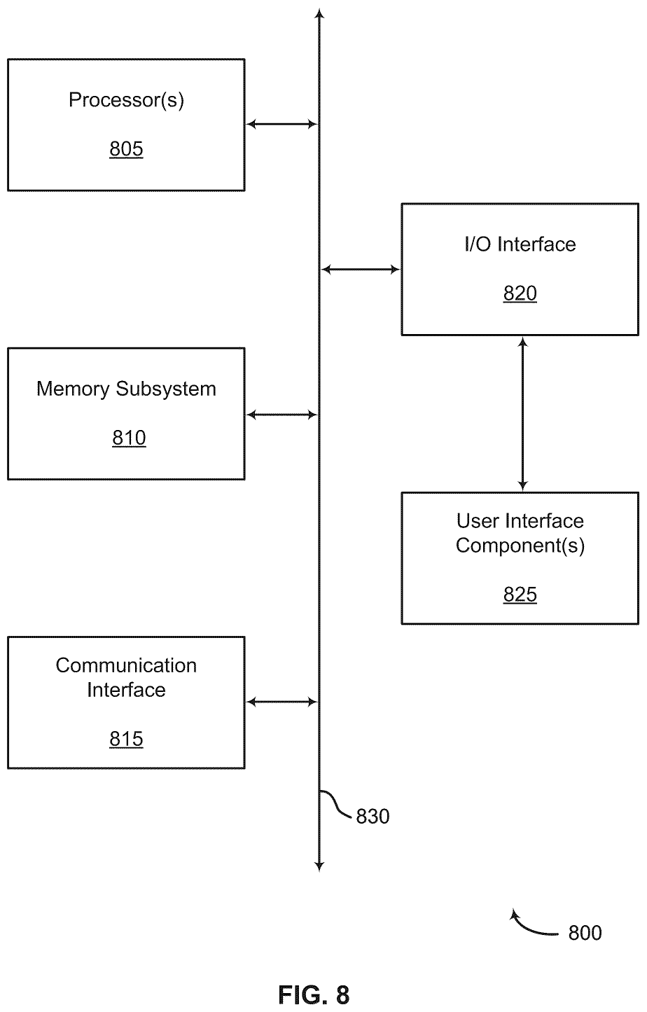

FIG. 8 shows an example of a computing device 800 according to aspects of the present disclosure. The example shown includes computing device 800, processor(s), memory subsystem 810, communication interface 815, I/O interface 820, user interface component(s), and channel 830.

In some embodiments, computing device 800 is an example of, or includes aspects of, object counting apparatus 100 of FIG. 1. In some embodiments, computing device 800 includes one or more processors 805 that can execute instructions stored in memory subsystem 810 to obtain a digital image; segment the digital image using a first segmentation parameter to obtain a first region and a second region; segment the second region based on a size of the second region using a second segmentation parameter different from the first segmentation parameter to obtain a third region; and generate a count of objects in the digital image by incrementing based on the first region and the third region.

According to some aspects, computing device 800 includes one or more processors 805. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 810 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 815 operates at a boundary between communicating entities (such as computing device 800, one or more user devices, a cloud, and one or more databases) and channel 830 and can record and process communications. In some cases, communication interface 815 is provided to enable a processing system coupled to a transceiver (e.g., a transmitter and/or a receiver). In some examples, the transceiver is configured to transmit (or send) and receive signals for a communications device via an antenna.

According to some aspects, I/O interface 820 is controlled by an I/O controller to manage input and output signals for computing device 800. In some cases, I/O interface 820 manages peripherals not integrated into computing device 800. In some cases, I/O interface 820 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 820 or via hardware components controlled by the I/O controller.

According to some aspects, user interface component(s) 825 enable a user to interact with computing device 800. In some cases, user interface component(s) 825 include an audio device, such as an external speaker system, an external display device such as a display screen, an input device (e.g., a remote control device interfaced with a user interface directly or through the I/O controller), or a combination thereof. In some cases, user interface component(s) 825 include a GUI.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining a digital image;
segmenting the digital image using a first segmentation parameter to obtain a first region and a second region;
segmenting the second region based on a size of the second region using a second segmentation parameter different from the first segmentation parameter to obtain a third region; and
generating a count of objects in the digital image by incrementing based on the first region and the third region.

2. The method of claim 1, further comprising:
capturing the digital image with an image sensor.

3. The method of claim 1, further comprising:
identifying a marker in the digital image; and
cropping the digital image based on the marker.

4. The method of claim 1, further comprising:
obtaining object shape information prior to segmenting the digital image, wherein the digital image is segmented based on the object shape information.

5. The method of claim 1, further comprising:
obtaining object color information prior to segmenting the digital image, wherein the digital image is segmented based on the object color information.

6. The method of claim 1, further comprising:
classifying the first region as a discrete object based on a size of the first region, wherein the count is based on the classification of the first region.

7. The method of claim 6, further comprising:
comparing a size of the first region to a median region size, wherein the classification of the first region is based on the comparison.

8. The method of claim 1, further comprising:
classifying the second region as an aggregate object based on a size of the second region, wherein the second region is segmented based on the classification of the second region.

9. The method of claim 1, further comprising:
classifying a fourth region as a fragment object based on a size of the fourth region.

10. The method of claim 1, further comprising:
performing a watershed process on the digital image, wherein the first segmentation parameter comprises a first watershed parameter.

11. The method of claim 10, further comprising:
performing the watershed process on the second region, wherein the second segmentation parameter comprises a second watershed parameter.

12. The method of claim 1, further comprising:
performing a first segmentation algorithm to obtain a fourth region; and
performing a second segmentation algorithm different from the first segmentation algorithm on the fourth region to obtain the third region.

13. The method of claim 1, further comprising:
iteratively segmenting regions of the digital image using different segmentation parameters until a termination condition is met, wherein the count is generated based on the termination condition.

14. The method of claim 1, further comprising:
displaying the count of objects via a user interface.

15. An apparatus comprising:
a light source;
an image sensor;
a textured surface disposed between the light source and the digital camera, wherein the textured surface is configured to separate objects; and
a processing component configured to generate a count of the objects by segmenting a digital image captured by the image sensor by using a first segmentation parameter to obtain a first region and a second region, and by segmenting the second region based on a size of the second region using a second segmentation parameter different from the first segmentation parameter to obtain a third region.

16. The apparatus of claim 15, further comprising:
a top-down digital camera configured to capture an image of the objects on a tray; and
a front-facing digital camera configured to decode a barcode of an object container.

17. The apparatus of claim 15, wherein:
the processing component is further configured to iteratively segment regions of the digital image using different segmentation parameters until a termination condition is met, wherein the count is generated based on the termination condition.

18. A non-transitory computer readable medium storing code, the code comprising instructions executable by a processor to:
obtain a digital image;
segment the digital image using a first segmentation parameter to obtain a first region and a second region;
segment the second region based on a size of the second region using a second segmentation parameter different from the first segmentation parameter to obtain a third region; and
generate a count of objects in the digital image by incrementing based on the first region and the third region.

19. The non-transitory computer readable medium of claim 18, wherein the code further comprises instructions executable by the processor to:
obtain object shape information prior to segmenting the digital image, wherein the digital image is segmented based on the object shape information.

20. The non-transitory computer readable medium of claim 18, wherein the code further comprises instructions executable by the processor to:
obtain object color information prior to segmenting the digital image, wherein the digital image is segmented based on the object color information.
